(19) United States
(12) Patent Application Publication
(10) Pub. No.: US 2013/0214191 A1
(43) Pub. Date: Aug. 22, 2013

(54) KIND OF GATE VALVE

(71) Applicant: Shuibo Li, Kunshan (CN)

(72) Inventor: Shuibo Li, Kunshan (CN)

(73) Assignee: KUNSHAN KINGLAI HYGIENIC MATERIALS CO., LTD., Kunshan, Jiangsu (CN)

(21) Appl. No.: 13/704,212

(22) PCT Filed: Apr. 9, 2012
(86) PCT No.: PCT/CN2012/073655

§ 371 Date: Dec. 13, 2012

(30) Foreign Application Priority Data
Feb. 22, 2012 (CN) 201220057556.0

(51) Int. Cl. F16K 3/314

(52) U.S. Cl. CPC F16K 3/314
USPC 251/326

(57) ABSTRACT

a kind of gate valve is provided by the present invention, comprising a valve body, a knife switch and a driving device, the valve body being provided with a media passage, and the knife switch being connected to the driving device and being driven to full open or close the media passage by the driving device, characterized in that the driving device comprises a driving source and a cross bar, wherein the driving source is connected with a center section of the cross bar, and both ends of the cross bar are respectively connected to the two ends of the knife switch via connectors. The present invention has advantages such as favorable tightness.

### BACKGROUND OF THE INVENTION

1. Field of the Invention

The present invention relates to the field of control valve, more particularly to a kind of gate valve.

2. The Prior Arts

Gate valve is a type of valve which serves to full open or close media motion in all kinds of transmission pipelines or equipments. The gate valve in the prior art mainly consists of a valve body and a knife switch movably arranged inside the valve body, wherein the valve body is provided with a media passage and the knife switch is utilized for opening or closing the media passage. For operation convenience, a driving device is often mounted on the knife switch so as to open or close the knife switch automatically.

At present, the gate valve in the prior art mostly employs gears to drive a metal vacuum bellow, and then drive the knife switch via a rocker arm to perform the action of opening and closing. However, due to the fact that in a mechanism composed of gears and racks the teeth thereon are easily to fray and even molder during operation, wide gaps readily appear which incur critical dislocation of actuating length distance thereof, resulting in a margin between paths of the two fixed spindles of the knife switch. Therefore the two fixed spindles could not drive the knife switch to open and close synchronously and in parallel, and could not make the knife switch to placidly seal the edge surface during closing, thus causing the phenomenon of poor tightness.

### SUMMARY OF THE INVENTION

Accordingly, the present invention seeks to solve the above mentioned problems by providing a kind of gate valve with favorable tightness.

To solve the problems mentioned above, a kind of gate valve is provided by the present invention, comprising a valve body, a knife switch and a driving device, the valve body being provided with a media passage, and the knife switch being connected to the driving device and being driven to full open or close the media passage by the driving device, characterized in that the driving device comprises a driving source and a cross bar, wherein the driving source is connected with a center section of the cross bar, and both ends of the cross bar are respectively connected to the two ends of the knife switch via connectors.

According to another aspect of the present invention, the two ends of the kind of valve body are provided with a leftward guide and a rightward guide vertically arranged, the cooperating leftward slider and rightward slider being mounted on the leftward guide and rightward guide respectively, wherein the leftward slider is connected with the rightward slider by the cross bar, and both ends of the cross bar are respectively connected to the two ends of the knife switch via connectors.

According to another aspect of the present invention, said connectors are metal vacuum bellows.

According to another aspect of the present invention, said driving source is a cylinder.

According to another aspect of the present invention, the edge of the knife switch is sheathed with a rubber seal.

Compared with products in the prior art, the present invention has advantages as follows:

Because the kind of gate valve of the present invention comprises a cross bar and a driving source connected with the center section of the cross bar, wherein both ends of the cross bar are respectively connected to the two ends of the knife switch via connectors, the driving force applied to the center section of the cross bar is transmitted evenly and synchronously to the two ends by the cross bar, and then transmitted to the two ends of the knife switch via the connectors at ends of the cross bar during operation. Due to the driving force generated by the driving source being transmitted evenly, synchronously and in parallel to the two ends of the knife switch via the cross bar and the connectors at ends of the cross bar, the knife switch is driven to placidly seal the edge surface of the media passage during closing, thus the present invention acquires favorable tightness.

The foregoing and other objects, features, aspects and advantages of the present invention will become more apparent from the following detailed description of the present invention when taken in conjunction with the accompanying drawings.

### BRIEF DESCRIPTION OF THE DRAWING

The present invention will be apparent to those skilled in the art by reading the following detailed description of a preferred embodiment thereof, with reference to the attached drawings, in which:

FIG. 1 is a schematic diagram of the present invention;

FIG. 2 is a schematic diagram of the present invention;

FIG. 3 is a schematic diagram in full open status of the present invention;

FIG. 4 is a schematic diagram in full close status of the present invention.

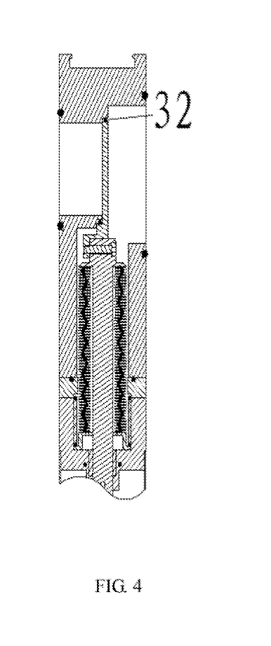

### DETAILED DESCRIPTION OF THE PREFERRED EMBODIMENT

The present invention will be further described in detail below by reference to accompanying drawings.

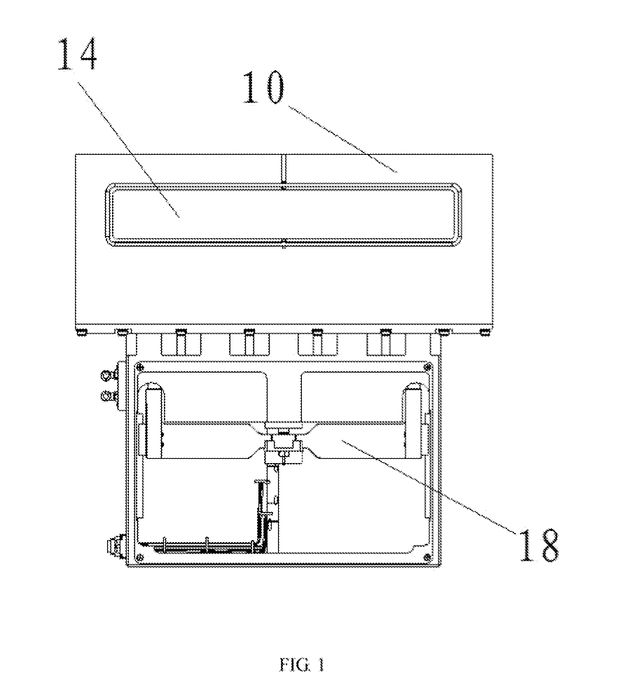

As shown in FIG. 1, a kind of gate valve is provided, comprising a valve body 10 and a knife switch12. The valve body 10 is provided with a media passage 14 utilized for media flow, and the knife switch 12 serves to full open or close the media passage 14. A driving device is mounted on the knife switch so as to open or close the knife switch 12 automatically. The driving device comprises a driving source 16, a cross bar 18 and connectors 20 at two ends of the cross bar, wherein both ends of the cross bar 18 are respectively connected to the two ends of the knife switch 12 via the connectors 20, and the center section of the cross bar 18 is connected with the driving source 16, the driving source 16 being fixed on the valve body 10. In order to enhance stationarity of the knife switch 12 that moves in axial driven by the cross bar 18, the leftward guide 201 and the rightward guide 202 are arranged respectively at two ends of the valve body 10, wherein the leftward slider 301 and the rightward slider 302 are respectively mounted on the leftward guide 201 and rightward guide 202, and the leftward slider 301 is connected with the rightward slider 302 by the cross bar 18.

During operation, the driving source 16 is preferably a cylinder, and the connectors 20 are preferably metal vacuum bellows. The driving force generated by the driving source 16 is transmitted evenly, synchronously and in parallel to the two ends by the cross bar 18 via the center section of the cross bar 18, and finally transmitted synchronously and in parallel to the two ends of the knife switch via the connectors 20. As both ends of the knife switch 12 could be forced synchronously and in parallel, the knife switch 12 is capable of placidly sealing the edge surface of the media passage 14 during closing.

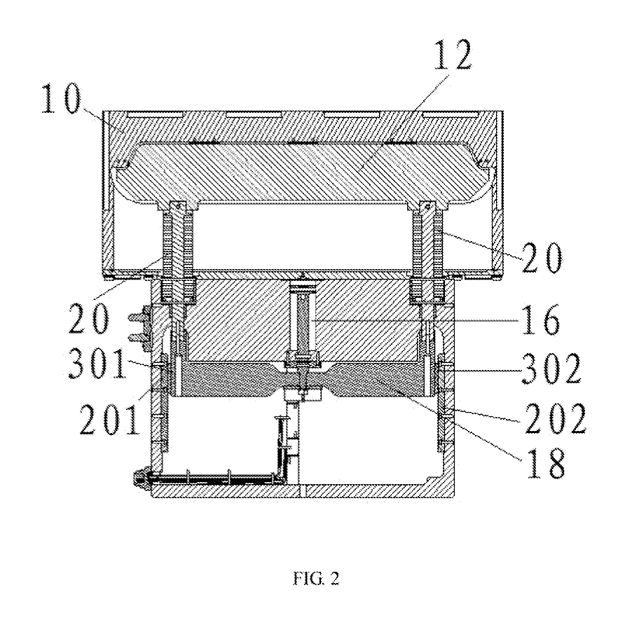

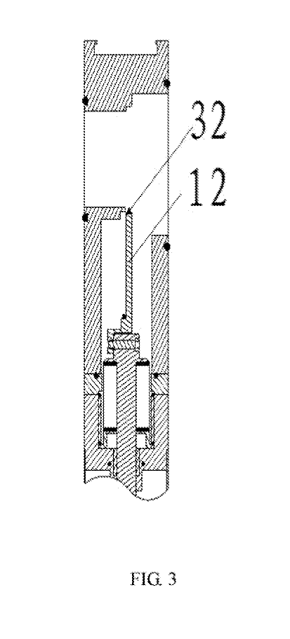

As shown in FIG. 2 and FIG. 3, a rubber seal 32 is arranged at the edge of the knife switch 12 to further enhance tightness. The rubber seal 32 allows the knife switch 12 to seal the edge surface of the media passage 14 more tightly, whereby tightness of the kind of gate valve is enhanced.

The embodiments described herein are representative of preferred embodiments and are not intended as limitations on the scope of the present invention. Any modification and equivalent replacement that doesn't depart from the spirit of the invention is considered to be within the scope of the invention as defined by the disclosure.

1. A kind of gate valve, comprising a valve body, a knife switch and a driving device, the valve body being provided with a media passage, and the knife switch being connected to the driving device and being driven to full open or close the media passage by the driving device, characterized in that the driving device comprises a driving source and a cross bar, wherein the driving source is connected with a center section of the cross bar, and both ends of the cross bar are respectively connected to the two ends of the knife switch via connectors.

2. The gate valve according to claim 1, wherein the two ends of the valve body are provided with a leftward guide and a rightward guide vertically arranged, the cooperating leftward slider and rightward slider being mounted on the leftward guide and rightward guide respectively, wherein the leftward slider is connected with the rightward slider by the cross bar, and both ends of the cross bar are respectively connected to the two ends of the knife switch via connectors.)

3. The gate valve according to claim 1, wherein said connectors are metal vacuum bellows.

4. The gate valve according to claim 1, wherein said driving source is a cylinder.

5. The gate valve according to claim 4, wherein the edge of the knife switch is sheathed with a rubber seal.
